(19) United States
(12) Patent Application Publication
(10) Pub. No.: US 2013/0122828 A1
(43) Pub. Date: May 16, 2013

(54) MOBILE TERMINAL WITH ANTENNA TO TUNE A RESONANCE FREQUENCY BAND AND OPERATING METHOD THEREOF

(71) Applicant: Pantech Co., Ltd, Seoul (KR)

(72) Inventor: Chang Ryul CHOI, Seoul (KR)

(73) Assignee: Pantech Co., Ltd, Seoul (KR)

(21) Appl. No.: 13/677,700

(22) Filed: Nov. 15, 2012

(30) Foreign Application Priority Data
Nov. 16, 2011 (KR) 10-2011-0119450

(51) Int. Cl. H04B 1/38

(52) U.S. Cl. CPC H04B 1/3827
USPC 455/77

(57) ABSTRACT

A mobile terminal including an antenna to change an operating frequency band includes a sub-resonance generator that generates a sub-resonance to shift the operating frequency band. The sub-resonance generator may be electrically or physically connected to a main antenna of the mobile terminal. The sub-resonance generator is connected to at least one impedance matcher and switch, and the opening and closing of the switch results in the generation of the sub-resonance. A sub-resonance generated in a higher frequency band than a first frequency band of the antenna device may result in the shift to a third frequency band with a main resonance at a lower frequency than the main resonance of the first frequency band and vice versa.

### CROSS-REFERENCE TO RELATED APPLICATION

This application claims priority from and the benefit of Korean Patent Application No. 10-2011-0119450, filed on Nov. 16, 2011, which is incorporated by reference for all purposes as if fully set forth herein.

### BACKGROUND

1. Field

The following description relates to a mobile terminal including an antenna, and more particularly, to a mobile terminal including an antenna to support multiple bands by changing a resonance frequency band and a method of operating the antenna of the mobile terminal.

2. Discussion of the Background

The development of mobile terminals is leading to the same or similar communication scheme being used globally. There is increasing demand for a mobile terminal capable of using communication services provided at any location globally. Even though the same communication scheme may be used by different communication services, different frequency bands may be used by each communication service to provide the communication service according to the standards of each nation. Thus, there is a desire for a mobile terminal capable of transmitting and receiving data in several frequency bands, in addition to a reference frequency band.

One method of enhancing the data transmission speed of a mobile terminal relates to transmitting and receiving data using a relatively wide frequency band.

There is a desire for a mobile terminal that may operate in a wide frequency band or dual/triple frequency bands including those in which a low frequency band corresponds to a wideband. However, it may be difficult to miniaturize an antenna capable of using the wide frequency band or an antenna capable of using the dual/triple frequency bands.

### SUMMARY OF THE INVENTION

Exemplary embodiments of the present invention provide a mobile terminal with an antenna device to transmit and receive data in several frequency bands.

Exemplary embodiments of present invention also provide a method for operating an antenna device to transmit and receive data in several frequency bands.

Additional features of the invention will be set forth in the description which follows, and in part will be apparent from the description, or may be learned by practice of the invention.

An exemplary embodiment of the present invention discloses an antenna device, including: a main antenna unit to transmit and receive signals in a first frequency band; a sub-resonance generator with a changeable length to modify the first frequency band; wherein if the sub-resonance generator is operated, the first frequency band is shifted to a second frequency band in which signals are transmittable and receivable.

An exemplary embodiment of the present invention also discloses a mobile terminal, including: a main antenna unit to transmit and receive signals in a first frequency band; a sub-resonance generator with a changeable length to modify the first frequency band; a first impedance matcher connected to the sub-resonance generator; a first switch connected to the first impedance matcher; and wherein if the first switch is closed, the length of the sub-resonance generator is changed and the first frequency band is shifted to a second frequency band.

An exemplary embodiment of the present invention also discloses a method for transmitting and receiving a signal in an antenna unit, including: generating a first main resonance in a first frequency band; generating a sub-resonance in a second frequency band to shift the first frequency band to a third frequency band; transmitting and receiving a signal in the third frequency band.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram illustrating a configuration of an antenna device of a mobile terminal according to an exemplary embodiment of the present invention.

FIG. 2 is a diagram illustrating a configuration of an antenna device of a mobile terminal according to an exemplary embodiment of the present invention.

FIG. 3 is a diagram illustrating a configuration of an antenna device of a mobile terminal according to an exemplary embodiment of the present invention.

FIG. 4A is a diagram illustrating a resonance frequency band of an antenna device according to an exemplary embodiment of the present invention.

FIG. 4B is a diagram illustrating a change in a resonance frequency band of an antenna device according to an exemplary embodiment of the present invention.

FIG. 5A is a diagram illustrating a resonance frequency band of an antenna device according to an exemplary embodiment of the present invention.

FIG. 5B is a diagram illustrating a change in a resonance frequency band of an antenna device according to an exemplary embodiment of the present invention.

FIG. 6A is a diagram illustrating a resonance frequency band of an antenna device according to an exemplary embodiment of the present invention.

FIG. 6B is a diagram illustrating a change in a resonance frequency band of an antenna device according to an exemplary embodiment of the present invention.

FIG. 7A is a diagram illustrating a resonance frequency band of an antenna device according to an exemplary embodiment of the present invention.

FIG. 7B is a diagram illustrating a change in a resonance frequency band of an antenna device according to an exemplary embodiment of the present invention.

FIG. 8A is a diagram illustrating a resonance frequency band of an antenna device according to an exemplary embodiment of the present invention.

FIG. 8B is a diagram illustrating a change in a resonance frequency band of an antenna device according to an exemplary embodiment of the present invention.

FIG. 9 is a diagram illustrating a configuration of an antenna device of a mobile terminal according to an exemplary embodiment of the present invention.

FIG. 10 is a block diagram illustrating a configuration of a mobile terminal according to an exemplary embodiment of the present invention.

FIG. 11 is a flowchart illustrating a method for operating an antenna device of a mobile terminal according to an exemplary embodiment of the present invention.

### DETAILED DESCRIPTION OF THE ILLUSTRATED EMBODIMENTS

Exemplary embodiments of the invention are described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “connected to” another element, it can be directly connected to the other element, or intervening elements may be present. In contrast, when an element is referred to as being “directly connected to” another element, there are no intervening elements present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

A mobile terminal may communicate with a base station using an antenna device. The antenna device may transmit or receive an electromagnetic wave in an operating frequency band while failing to transmit or receive an electromagnetic wave in a frequency band other than the operating frequency band. In other words, the operating frequency band of an antenna incorporated in a mobile terminal may correspond to a frequency band in which the mobile terminal may transmit or receive an electromagnetic wave.

The present disclosure describes a configuration of a mobile terminal incorporating an antenna device that may change an operating frequency band.

A configuration and operation of an antenna device of a mobile terminal may be provided according to one or more, alone or in combination, exemplary embodiments of the present invention.

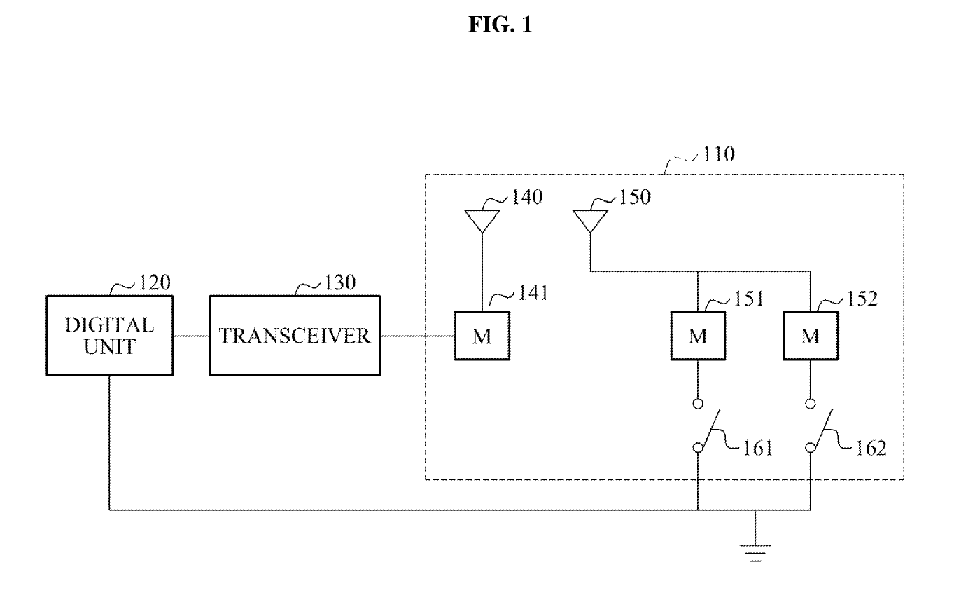

FIG. 1 is a diagram illustrating a configuration of an antenna device of a mobile terminal according to an exemplary embodiment of the present invention.

An antenna device 110 according to exemplary embodiments may include a main antenna unit 140, a sub-resonance generator 150, an impedance matcher 141, an impedance matcher 151, an impedance matcher 152, a switching unit 161, and a switching unit 162.

A digital unit 120 may generate a transmission signal in a base band, and a transceiver 130 may modulate the transmission signal to match a first frequency band.

The main antenna unit 140 may be connected to the transceiver 130 through the impedance matcher 141. The main antenna unit 140 may set the first frequency band to a resonance frequency band. In other words, the main antenna unit 140 may generate a main resonance in the first frequency band, and use the main resonance to radiate, to the first frequency band, the transmission signal modulated by the transceiver 130, or receive a reception signal of the first frequency band.

The antenna device 110 may change an operational frequency band if another frequency band is to be supported, for example, a third frequency band in addition to the first frequency band. At least one of the switching unit 161 and the switching unit 162 may be closed to activate the sub-resonance generator 150. The sub-resonance generator 150 may be connected to the transceiver 130 through the impedance matcher 151 and the impedance matcher 152. Although depicted as connected to the sub-resonance generator 150 in parallel, the impedance matcher 151 and impedance matcher 152 may be connected in series with the sub-resonance generator 150.

To change the main resonance of the first frequency band generated by the main antenna unit 140 to another frequency band, the sub-resonance generator 150 may generate a sub-resonance or parasitic resonance in a second frequency band. Sub-resonance may refer to a resonance generated to change the main resonance to another frequency band, and may not refer to a general resonance, for example, the main resonance generated to transmit and receive an electromagnetic wave. A region of the second frequency band in which the sub-resonance may be generated may be determined based on a capacitance value and an inductance value of the impedance matcher 151 and/or the impedance matcher 152 if one or both of the switching unit 161 and the switching unit 162 are closed.

The second frequency band in which the sub-resonance may be generated may or may not overlap with the first frequency band. The sub-resonance may not be used for transmitting and receiving a signal. The sub-resonance may not reach a point at which an antenna efficiency may be sufficient for transmitting and receiving a signal, for example, when a voltage standing wave ratio (VSWR) is less than or equal to three (“VSWR≦3”).

In response to the sub-resonance generator 150 being activated and the sub-resonance being generated in the second frequency band, a position of the main resonance generated in the first frequency band may change. For example, if the sub-resonance is generated in a higher frequency band than the first frequency band (for example, if the second frequency band corresponds to a higher frequency band than the first frequency band), the main resonance may shift to a lower frequency band than the first frequency band. If the sub-resonance is generated in a lower frequency band than the first frequency band (for example, if the second frequency band corresponds to a lower frequency band than the first frequency band), the main resonance may shift to a higher frequency band than the first frequency band.

Thus, as the switching unit 161 and the switching unit 162 are opened or closed, the resonance frequency band of the antenna device 110 may shift to the third frequency band, and the antenna device 110 may radiate a transmission signal using the third frequency band, or may receive a reception signal in the third frequency band.

The sub-resonance generator 150 may generate the sub-resonance at a position separated from the first frequency band by a value approximately in the range of 50 megahertz (MHz) to 500 MHz.

The sub-resonance generator 150 may include a radiator plated with a metal, such as stainless use steel, and the impedance matcher 151 and the impedance matcher 152 may include a circuit having a capacitor. Further, the sub-resonance generator 150 may include a combination of a printed circuit board (PCB) pattern and a capacitor. The impedance matcher 151 and the impedance matcher 152 may include a combination of elements, such as an inductor, a capacitor, and the like, or may include a tunable capacitor.

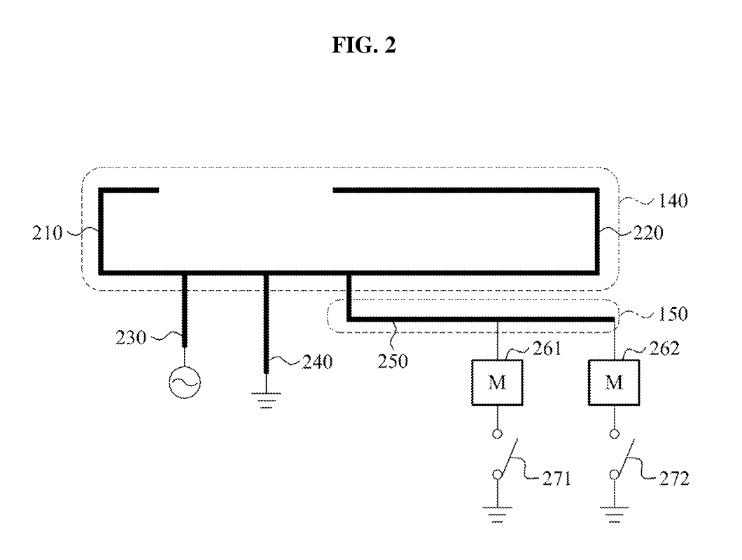

FIG. 2 is a diagram illustrating a configuration of an antenna device of a mobile terminal according to an exemplary embodiment of the present invention.

Referring to FIG. 2, a main antenna unit 140 may receive a transmission signal from the transceiver 130, and may radiate a transmission signal using a main resonance generated in a first frequency band. The main antenna unit 140 may include a high-band radiator 210 to generate a resonance in a high-band, a low-band radiator 220 to generate a resonance in a low-band, a signal feeding unit 230, and a ground feeding unit 240.

To change a main resonance of a first frequency band generated by the main antenna unit 140 to another frequency band, a sub-resonance generator 150 may generate a sub-resonance in a second frequency band. The sub-resonance generator 150 may be connected to the high-band radiator 210 and the low-band radiator 220. The sub-resonance generator 150 may include a sub-branch pattern 250 that is connected to the high-band radiator 210 and the low-band radiator 220 of the main antenna unit 140, at least one impedance matcher, for example, the impedance matcher 261 and/or the impedance matcher 262, and at least one switching unit, for example, the switching unit 271 and/or the switching unit 272, respectively. Each of the impedance matcher 261 and the impedance matcher 262 may correspond to one of the switching unit 271 and the switching unit 272. Although depicted as connected to the sub-resonance generator 150 in parallel, the impedance matcher 261 and impedance matcher 262 may be connected in series with the sub-resonance generator 150. FIG. 2 illustrates a configuration in which the sub-branch pattern 250 is electrically connected to the high-band radiator 210 and the low-band radiator 220 of the main antenna unit 140 through a physical and direct connection.

Referring to FIG. 2, if the sub-resonance generator 150 is activated by the closing of the switching unit 271 and/or the switching unit 272, a capacitance value and an overall inductance value of the antenna device 110 may change according to a capacitance value (C) and an inductance value (L) of the impedance matcher 261 and/or the impedance matcher 262 corresponding to the switching unit 271 and/or the switching unit 272, respectively, being closed. The change in the capacitance value and in the inductance value may result in a sub-resonance being generated, and a position of the main resonance may change. By turning each of the switching unit 271 and the switching unit 272 either ON or OFF a length of a pattern starting from a branch point to a point where a switching unit is connected to a ground may be varied. A branch point may be a point from a radiator of a main antenna of a sub-branch pattern 250. By adjusting an amount C of a capacitance applied to the impedance matcher 261 and impedance matcher 262, a frequency band (that is, the second frequency band) in which a sub-resonance is generated may be adjusted. The second frequency band may be determined based on the following equation.

$$F 2 \approx \frac{1}{2 π \sqrt{LC}}$$

In this equation, F2 denotes the second frequency band.

If the sub-resonance generator 150 has a single switching unit and a single impedance matcher, a value L may be fixed and the sub-resonance may be generated in the second frequency band by adjusting an amount C of a capacitance of the single impedance matcher. If the sub-resonance generator 150 has a plurality of switching units and a plurality of impedance matchers, the value L may be varied and the value L may be adjusted by turning ON or OFF a switching unit selected from among the plurality of switching units, and the amount C of an impedance matcher may also be adjusted according to switching ON or OFF the switching unit connected to a ground, thereby generating a sub-resonance in the second frequency band.

The high-band radiator 210 and the low-band radiator 220 of the main antenna unit 140 may be connected to the sub-branch pattern 250 of the sub-resonance generator 150. The high-band radiator 210 or the low-band radiator 220 may be selectively connected to the sub-branch pattern 250 of the sub-resonance generator 150 according to whether the first frequency band to be changed corresponds to a low band or a high band. For example, if the first frequency band corresponds to the high band, i.e., if a main resonance conforming to a reference frequency band of the high band, is to be changed to another frequency band with a lower frequency, the sub-branch pattern 250 of the sub-resonance generator 150 may be operated with the high-band radiator 210 of the main antenna unit 140. If the first frequency band corresponds to the low band, i.e., if a main resonance conforming to a reference frequency band of the low band, is to be changed to another frequency band with a higher frequency, the sub-branch pattern 250 of the sub-resonance generator 150 may be operated with the low-band radiator 220 of the main antenna unit 140. If the sub-branch pattern 250 of the sub-resonance generator 150 is connected to the low-band radiator 220 of the main antenna unit 140, the value L and/or the amount C of the sub-resonance generator 150 may be adjusted, thereby changing a main resonance conforming to a reference frequency band of the high band to another frequency band, for example, the value L and/or the amount C may be adjusted to a lower value. If the sub-branch pattern 250 of the sub-resonance generator 150 is connected to the high-band radiator 210 of the main antenna unit 140, the value L and/or the amount C of the sub-resonance generator 150 may be adjusted, thereby changing a main resonance conforming to a reference frequency band of the low band to another frequency band. For example, the value L and the amount C may be adjusted to a higher value. Although illustrated as being physically and directly connected to the main antenna unit, the sub-branch pattern may be connected thereto via a circuit element to selectively connect to the main antenna unit, e.g., a push switch, a push-to-break switch, a single pole on-off switch, a 2-way switch, a dual on-off switch, a relay, a diode, etc.

The sub-resonance generator 150 may be disposed adjacent to a metal material. The sub-resonance generator 150 may be used to change a main resonance of the main antenna unit 140 by generating a sub-resonance in a second frequency band. However, the sub-resonance generator 150 need not use the entire generated waveform to change the main resonance of the main antenna unit 140 to the reference frequency band. For example, the sub-resonance generator 150 may shift the main resonance of the main resonance using a sub-resonance of the second frequency band. An antenna may be isolated from a metal material or another antenna because a metal material or another antenna may interfere with an operation of the antenna if located adjacent to the antenna. However, the sub-resonance generator 150 may not be used as an antenna that radiates an electromagnetic wave and thus, a metal material or another antenna disposed to be adjacent to the sub-resonance generator 150 may not interfere with an operation of the sub-resonance generator 150. Accordingly, the sub-resonance generator 150 may be disposed at a position irrespective of a distance from a metal material and thus, may allow for more flexible arrangement of an internal space of a mobile terminal.

In the antenna device illustrated in FIG. 2, the sub-resonance generator 150 is connected to the low-band radiator 220 of the main antenna unit 140. However, the sub-resonance generator 150 may be connected to the high-band radiator 210 of the main antenna unit 140, or connected to both the high-band radiator 210 and the low-band radiator 220. In other words, the sub-branch pattern 250 may be physically connected to a portion of the main antenna unit 140 at one or both of the high-band radiator 210 and the low band radiator 220.

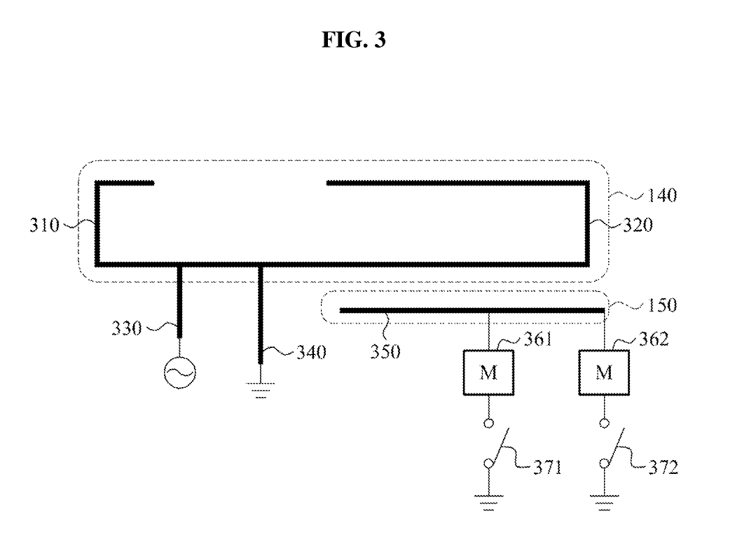

FIG. 3 is a diagram illustrating a configuration of an antenna device of a mobile terminal according to an exemplary embodiment of the present invention.

Referring to FIG. 3, a sub-resonance generator 150 may be electrically coupled to a main antenna unit 140 rather than being physically connected to the main antenna unit 140. The sub-resonance generator 150 may be electrically coupled to a low-band radiator 320 through a sub-branch pattern 350 without being physically connected to the low-band radiator 320. If the sub-branch pattern 350 is disposed to be adjacent to the low-band radiator 320, the sub-branch pattern 350 may be electrically coupled to the low-band radiator 320. In response to a sub-resonance being generated in a second frequency band due to the sub-branch pattern 350 and the low-band radiator 320 being electrically coupled to each other, a main resonance in a first frequency band may change to a third frequency band. In response to the switching unit 371 and the switching unit 372 being opened or closed, overall values of a capacitance and an inductance of antenna device may change. The configurations and operations of a high-band radiator 310 of the main antenna unit 140, a signal feeding unit 330 of the main antenna unit 140, a ground feeding unit 340, and impedance matcher 361 and impedance matcher 362 illustrated in FIG. 3, are similar to those provided with reference to FIG. 2, and further descriptions thereof are omitted.

In the antenna device illustrated in FIG. 3, the sub-resonance generator 150 is electrically coupled to the low-band radiator 320 of the main antenna unit 140. However, the sub-resonance generator 150 may be electrically coupled the high-band radiator 310 of the main antenna unit 140 or electrically coupled to both the low-band radiator 320 and the high-band radiator 310.

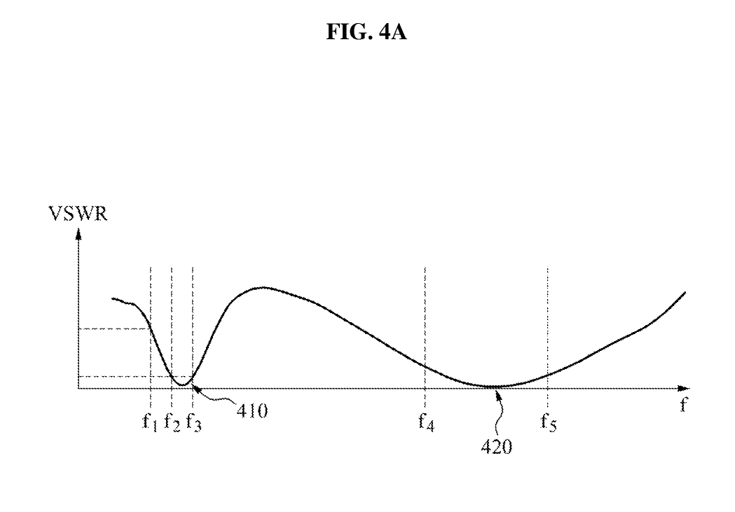

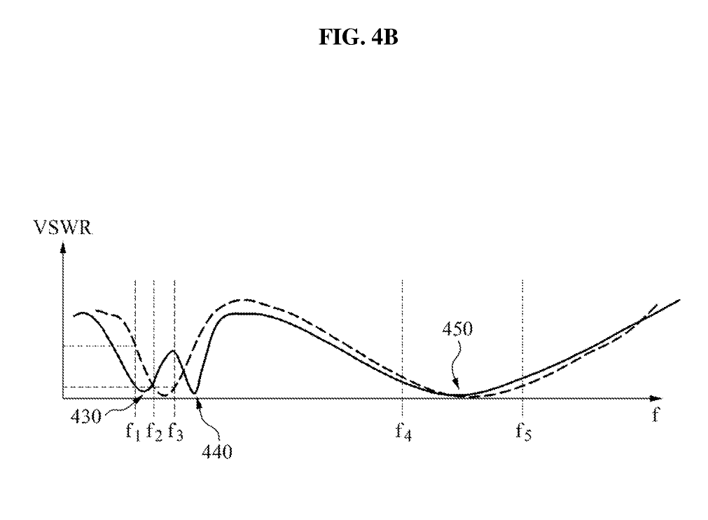

FIG. 4A is a diagram illustrating a resonance frequency band of an antenna device according to an exemplary embodiment of the present invention. FIG. 4B is a diagram illustrating a change in a resonance frequency band of an antenna device according to an exemplary embodiment of the present invention.

Referring to FIG. 4A and FIG. 4B, a vertical axis denotes a voltage standing wave ratio (VSWR), and a horizontal axis denotes a frequency. A voltage standing wave may refer to an electromagnetic wave generated by being superimposed on a reflected wave of an electromagnetic wave based on a boundary interface. A relatively high VSWR may indicate a relatively high number of reflected waves for a given electromagnetic wave. FIG. 4A and FIG. 4B illustrate a VSWR generated by a dual band antenna and will be described as if generated by any of the antenna devices of FIG. 1, FIG. 2, and FIG. 3, but is not limited thereto.

At a resonance frequency of an antenna device, most electromagnetic waves may be radiated through an antenna and thus, the VSWR may be relatively low. Referring to FIG. 4A and FIG. 4B, a frequency band in which a value of the VSWR is relatively low may correspond to a frequency band in which a resonance is generated.

FIG. 4A illustrates a VSWR before the sub-resonance generator 150 is activated.

Referring to FIG. 4A, a main resonance is generated in a low band corresponding to a band 410 between a frequency f₂ and a frequency f₃ and a high band corresponding to a band 420 between a frequency f₄ and a frequency f₅. Thus, a first frequency band in which a main resonance is generated may correspond to the band 410 between the frequency f₂ and the frequency f₃ and the band 420 between the frequency f₄ and the frequency f₅. If the frequency f₁, the frequency f₂, and the frequency f₃ are included in the low band used by a mobile terminal, antenna efficiency may not be high at each of the frequency f₁, the frequency f₂, and the frequency f₃. A frequency in the band 410 between the frequency f₂ and the frequency f₃ may be used in a communication environment, and the main antenna unit 140 may be calibrated to operate in the band 410 between the frequency f₂ and the frequency f₃ for the low band. For a main antenna unit 140 calibrated to operate in the band 410 the antenna efficiency may be degraded in a band around the frequency f₁. If the mobile terminal is used in another communication environment which utilizes the band between the frequency f₁ and the frequency f₂, such as a roaming communication environment, and the like, antenna efficiency may be maintained by the generation of a sub-resonance. The generation of a sub-resonance may result in the shift of the resonance frequency to between the frequency f₁ and the frequency f₂. Thus, an antenna device of a mobile terminal may generate a sub-resonance through the sub-resonance generator 150, and may thereby shift a main resonance generated by the main antenna unit 140 to a frequency band utilized by a communication environment.

FIG. 4B illustrates a VSWR after the sub-resonance generator 150 is activated. Referring to FIG. 4B, a sub-resonance may be generated in a second frequency band 440 rather than the first frequency band. The second frequency band 440 may be generated at a frequency in an opposite direction to a direction in which the first frequency band is to be shifted. Referring to FIG. 4B, a main resonance in a low band before the sub-resonance generator 150 is activated, depicted by a dashed line, may be shifted to a lower frequency band, i.e., from a first frequency band (corresponding to a band between a frequency f₂ and a frequency f₃) to a third frequency band (corresponding to a band 430 between a frequency f₁ and a frequency f₂) by the generation of a sub-resonance in an opposite direction to the band from the first frequency band, i.e., in a higher frequency band based on the band between the frequency f₂ and the frequency f₃. Comparing the main resonance before and after the sub-resonance generator 150 is activated, a main resonance generated in the low band may be shifted to the band 430 between the frequency f₁ and the frequency f₂, and a main resonance generated in a high band may remain in a band 450 between a frequency f₄ and a frequency f₅. Thus, a frequency band of a main resonance in the low band may be adjusted while maintaining a main resonance in the high band.

Referring to FIG. 4A, before the sub-resonance generator 150 is activated, the mobile terminal may transmit and receive data using a main resonance generated in the first frequency band corresponding to the band 410 between the frequency f₂ and the frequency f₃ and the band 420 between the frequency f₄ and the frequency f₅. Referring to FIG. 4B, after the sub-resonance generator 150 is activated, the main resonance may be shifted to the third frequency band corresponding to the band 430 between the frequency f₁ and the frequency f₂ and the band 450 between the frequency f₄ and the frequency f₅, and the mobile terminal may transmit and receive data using the third frequency band.

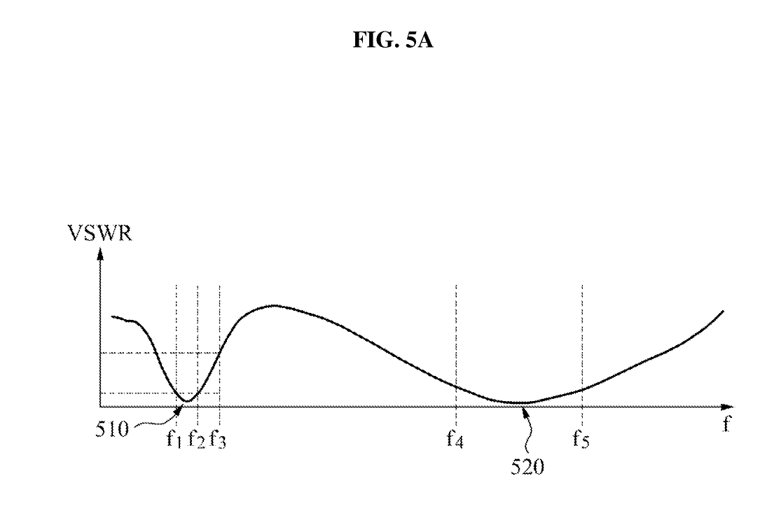

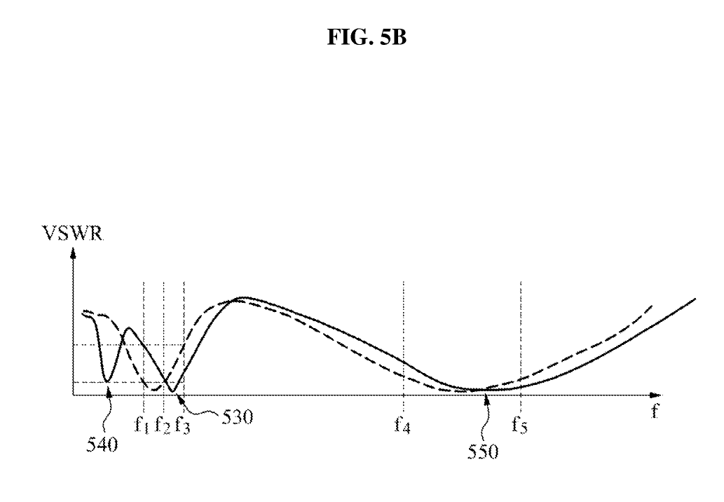

FIG. 5A is a diagram illustrating a resonance frequency band of an antenna device according to an exemplary embodiment of the present invention. FIG. 5B is a diagram illustrating a change in a resonance frequency band of an antenna device according to an exemplary embodiment of the present invention. FIG. 5A and FIG. 5B illustrate a VSWR generated by a dual band antenna and will be described as if generated by any of the antenna devices of FIG. 1, FIG. 2, and FIG. 3, but is not limited thereto.

FIG. 5A illustrates a VSWR before the sub-resonance generator 150 is activated. Referring to FIG. 5A, a main resonance is generated in a low band corresponding to a band 510 between a frequency f₁ and a frequency f₂ and a high band corresponding to a band 520 between a frequency f₄ and a frequency f₅. A mobile terminal may transmit and receive data using a main resonance generated in a first frequency band corresponding to the band 510 and the band 520. Referring to FIG. 5A, if a band between the frequency f₂ and the frequency f₃ is to be utilized antenna efficiency may degrade as the frequency increases toward frequency f₃. Accordingly to increase antenna efficiency in a band between the frequency f₂ and the frequency f₃, a sub-resonance may be generated by the sub-resonance generator 150 to change a main resonance in the low band from the first frequency band corresponding to the band 510 to a third frequency band corresponding to the band between the frequency f₂ and the frequency f₃.

FIG. 5B illustrates a VSWR after the sub-resonance generator 150 is activated. Referring to FIG. 5B, in response to the sub-resonance generator 150 being activated, a sub-resonance may be generated in a second frequency band 540, and a main resonance may be shifted to a third frequency band (corresponding to a band 530 between a frequency f₂ and a frequency f₃, and a band 550 between a frequency f₄ and a frequency f₅). Thus, a mobile terminal may transmit and receive data using the third frequency band (corresponding to the band 530 and the band 550). A main resonance in a low band may be shifted to a higher frequency band, that is, from a first frequency band (corresponding to a band between a frequency f₁ and the frequency f₂) to the third frequency band (for example, the band 530) by the generation of a sub-resonance in an opposite direction from the first frequency band, i.e., in a lower frequency band.

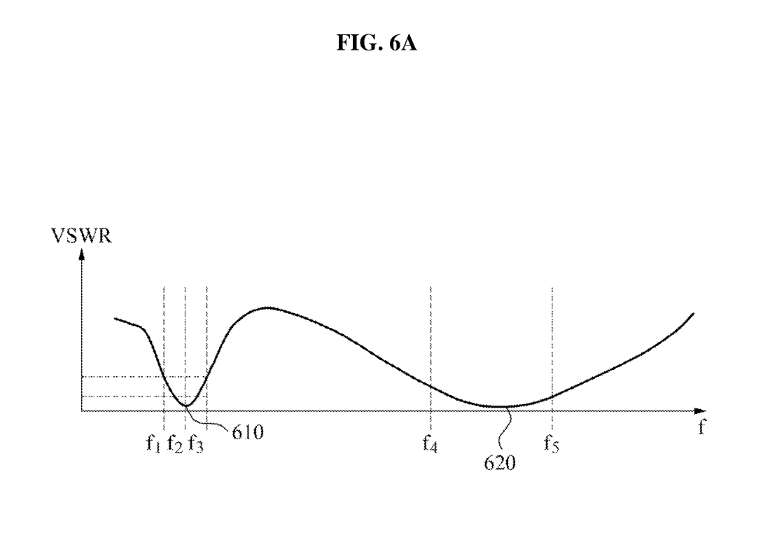

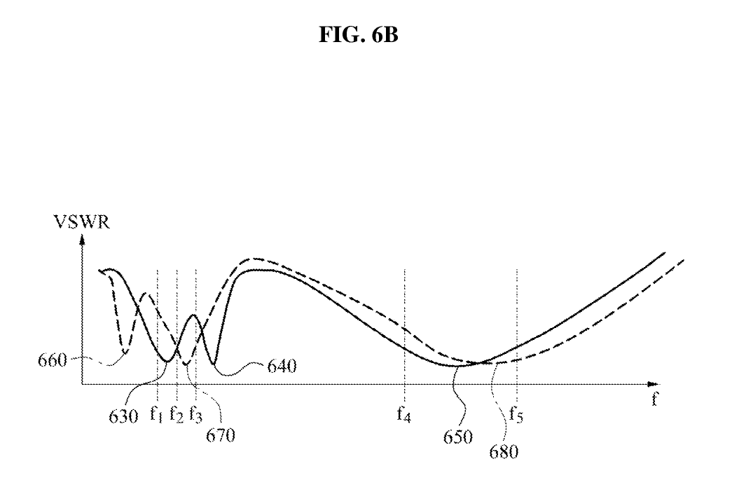

FIG. 6A is a diagram illustrating a resonance frequency band of an antenna device according to an exemplary embodiment of the present invention. FIG. 6B is a diagram illustrating a change in a resonance frequency band of an antenna device according to an exemplary embodiment of the present invention. FIG. 6B is a diagram illustrating an example of changing a resonance frequency band by generating a sub-resonance in a frequency band that is higher than the resonance frequency band, and an example of a resonance frequency band being changed by generating a sub-resonance in a frequency band that is lower than the resonance frequency band. FIG. 6A and FIG. 6B illustrate a VSWR generated by a dual band antenna and will be described as if generated by any of the antenna devices of FIG. 1, FIG. 2, and FIG. 3, but is not limited thereto.

FIG. 6A illustrates a VSWR before the sub-resonance generator 150 is activated. Referring to FIG. 6A, a main resonance is generated in a low band corresponding to a band 610 between a frequency f₁ and a frequency f₃ and a high band corresponding to a band 620 between a frequency f₄ and a frequency f₅. A mobile terminal may transmit and receive data using a main resonance generated in a first frequency band corresponding to the band 610 and the band 620.

FIG. 6B illustrates a VSWR after the sub-resonance generator 150 is activated. A solid line of FIG. 6B illustrates a sub-resonance 640 that is generated in a higher frequency band, when compared to an original main frequency 610 of FIG. 6A. The activation of sub-resonance generator 150 may result in the shift to a main resonance 630 in the low band between a frequency f₁ and a frequency f₂, and a main resonance 650 in a high band may remain in substantially the same frequency band.

A dotted line of FIG. 6B illustrates a sub-resonance 660 that is generated in a lower frequency band, when compared to the original main frequency 610. The activation of sub-resonance generator 150 may result in the shift to a main resonance 670 in the low band between the frequency f₂ and a frequency f₃, and a main resonance 680 in a high band may remain in substantially the same frequency band.

The mobile terminal may generate a sub-resonance in a second frequency band using the sub-resonance generator 150. In response to the sub-resonance generator 150 being activated, a main resonance may be shifted according to a sub-resonance generated by the sub-resonance generator 150. Thus, the mobile terminal may transmit and receive data using the shifted main resonance.

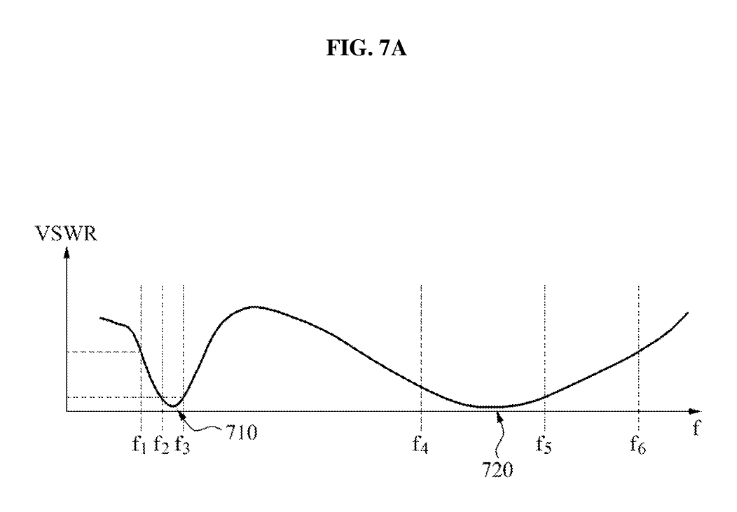

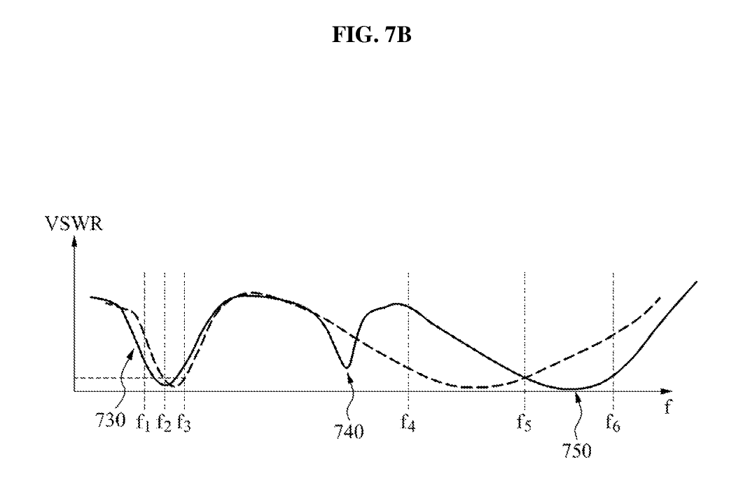

FIG. 7A is a diagram illustrating a resonance frequency band of an antenna device according to an exemplary embodiment of the present invention. FIG. 7B is a diagram illustrating a change in a resonance frequency band of an antenna device according to an exemplary embodiment of the present invention. FIG. 7A and FIG. 7B illustrate a VSWR generated by a dual band antenna and will be described as if generated by any of the antenna devices of FIG. 1, FIG. 2, and FIG. 3, but is not limited thereto.

Referring to FIG. 7A, before activation of the sub-resonance generator 150, an antenna device may transmit and receive data using a main resonance generated in a first frequency band corresponding to a band 710 between a frequency f₁ and a frequency f₂ and a band 720 between a frequency f₄ and a frequency f₅. Referring to FIG. 7B, activation of the sub-resonance generator 150 may result in a sub-resonance being generated in a second frequency band 740, and a shift in a main resonance to a third frequency band corresponding to a band 730 between a frequency f₁ and a frequency f₃ and a band 750 between a frequency f₅ and a frequency f₆. A mobile terminal may transmit and receive data using the third frequency band corresponding to the band 730 and the band 750.

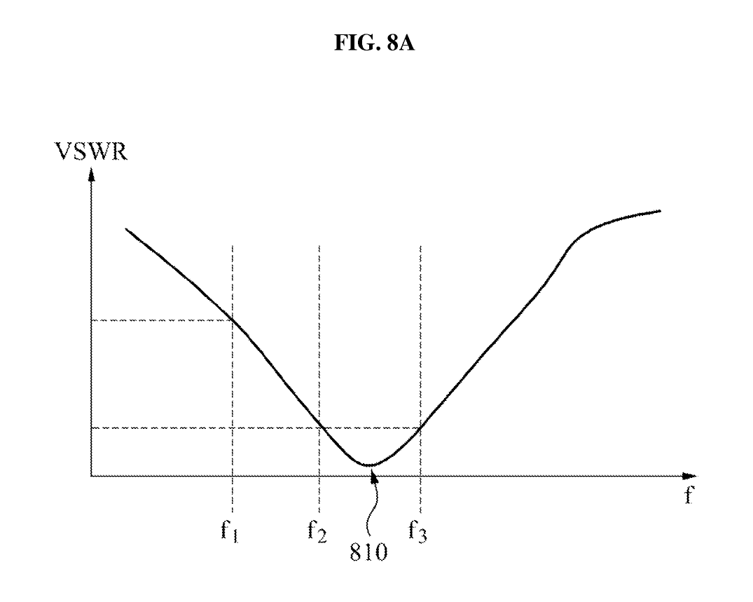

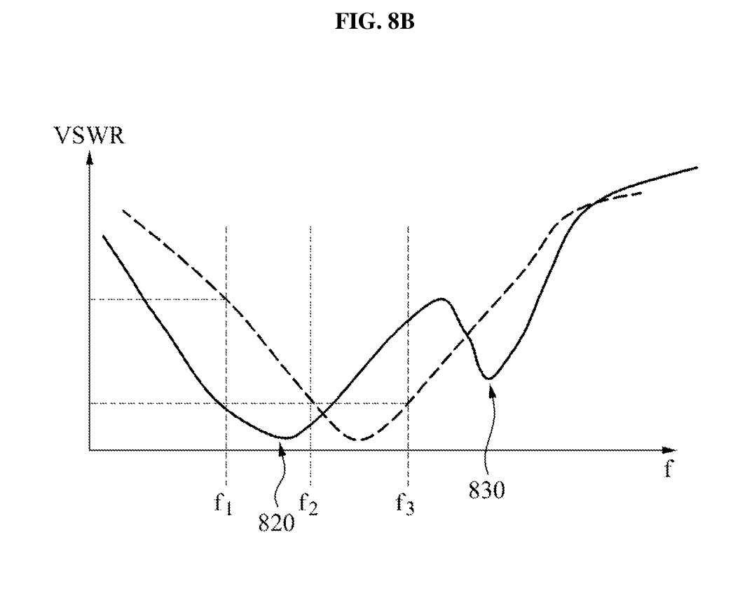

FIG. 8A is a diagram illustrating a resonance frequency band of an antenna device according to an exemplary embodiment of the present invention. FIG. 8B is a diagram illustrating a change in a resonance frequency band of an antenna device according to an exemplary embodiment of the present invention. FIG. 8A and FIG. 8B depicted a VSWR generated by a single-band antenna and will be described as if generated by any of the antenna devices of FIG. 1, FIG. 2, and FIG. 3, but is not limited thereto.

A main antenna unit 140 of a single-band antenna, in contrast to the dual-band antenna illustrated with reference to FIG. 4A through FIG. 7B, may generate a main resonance in a single frequency band. FIG. 8A illustrates a VSWR before a sub-resonance generator is activated. Referring to FIG. 8A, a main antenna unit 140 may generate a main resonance in a first frequency band 810 between a frequency f₂ and a frequency f₃.

FIG. 8B illustrates a VSWR after a sub-resonance generator 150 is activated. Referring to FIG. 8B, the sub-resonance generator 150 may generate a sub-resonance in a second frequency band 830. The activation of the sub-resonance generator may result in the shift of a resonance frequency to a band between a frequency f₂ and a frequency f₃ to a third frequency band 820 between a frequency f₁ and the frequency f₂, and thus a mobile terminal may transmit and receive data using the third frequency band 820.

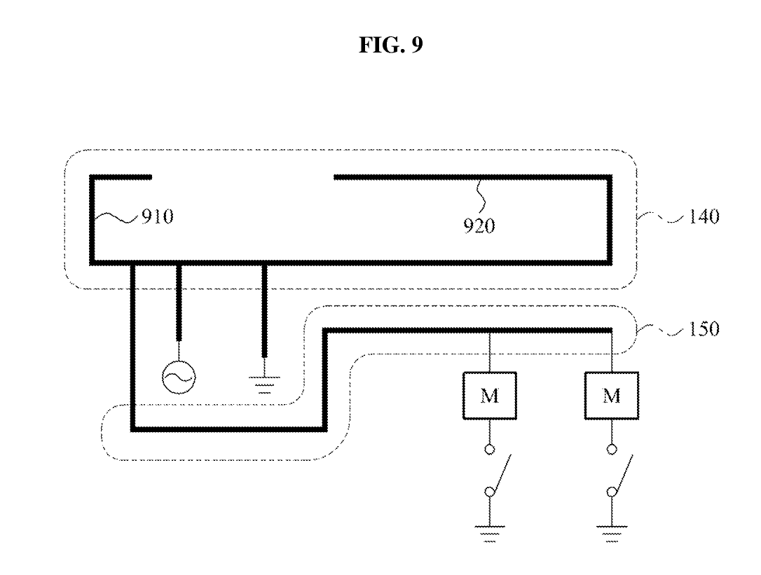

FIG. 9 is a diagram illustrating a configuration of an antenna device of a mobile terminal according to an exemplary embodiment of the present invention.

Referring to FIG. 9, the sub-resonance generator 150 is connected to a high-band radiator 910 selected from the high-band radiator 910 and a low-band radiator 920 included in the main antenna unit 140.

The sub-resonance generator 150 may be physically connected to the main antenna unit 140 as illustrated in FIG. 9, or may be electrically coupled to the main antenna unit 140 without being physically connected to the main antenna unit 140, as illustrated in FIG. 3.

The sub-resonance generator 150 may shift a main resonance conforming to a reference frequency band of a higher frequency band, to another frequency band. The sub-resonance generator 150 may shift a main resonance conforming to a reference frequency band of a low band to another frequency band by adjusting a value L and a value C of the sub-resonance generator 150.

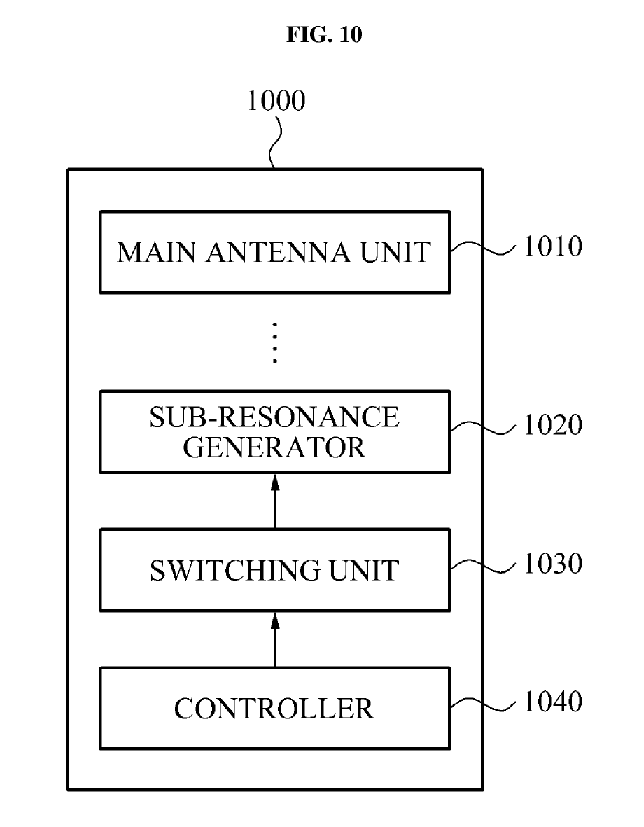

FIG. 10 is a block diagram illustrating a configuration of a mobile terminal according to an exemplary embodiment of the present invention.

A mobile terminal 1000 may include a main antenna unit 1010, a sub-resonance generator 1020, a switching unit 1030, and a controller 1040.

The main antenna unit 1010 may set a first frequency band to a resonance frequency band, and generate a main resonance in the first frequency band. The main antenna unit 1010 may transmit data to the first frequency band using the main resonance, or receive data from the first frequency band. The first frequency band may correspond to a single band, dual bands, triple bands, etc. If the first frequency band corresponds to more than a single band, the first frequency band may include a plurality of discontinuous frequency bands.

The sub-resonance generator 1020 may generate a sub-resonance in a second frequency band. The second frequency band may overlap with the first frequency band, or may be included in the first frequency band. The second frequency band in which the sub-resonance is generated may correspond to a frequency band separated from the first frequency band in the range of 50 MHz to 500 MHz.

If the first frequency band corresponds to dual bands, the main antenna unit 1010 may include a low-band radiator that forms a main resonance in a low band and a high-band radiator that forms a main resonance in a high band.

The sub-resonance generator 1020 may be connected to one of the low-band radiator and the high-band radiator.

In response to a sub-resonance being generated by the sub-resonance generator 1020, a position of the main resonance may be shifted from the first frequency band to a third frequency band. A portion of the third frequency band may overlap the first frequency band.

The sub-resonance generator 1020 may be physically connected to the main antenna unit 1010, or may be electrically coupled to the main antenna unit 1010 by being disposed adjacent to the main antenna unit 1010 rather than being physically connected to the main antenna unit 1010.

Opening and closing of the switching unit 1030 may be controlled by the controller 1040. In response to the switching unit 1030 being closed, the sub-resonance generator 1020 may be activated to generate a sub-resonance. In response to the switching unit 1030 being opened, the sub-resonance generator 1020 may be deactivated to produce an effect such that the sub-resonance ceases to exist.

The sub-resonance generator 1020 may be matched with a power feeding circuit using an impedance matcher. The impedance matcher may include a plurality of impedance matching circuits having different impedances. The switching unit 1030 may include a plurality of switches corresponding to each of the plurality of impedance matching circuits.

In response to different switches being closed, different impedance matching circuits may be connected to the sub-resonance generator 1020. An impedance of an antenna may change according to an impedance of an impedance matching circuit connected to the sub-resonance generator 1020. Generation of a sub-resonance and the changing of a main resonance may be determined based on a changed impedance of the antenna.

The sub-resonance generator 1020 may generate a sub-resonance using LC resonance. In response to the switching unit 1030 being closed, the sub-resonance generator 1020 may be activated and, a length of a pattern from a branch point of a radiator of the main antenna unit 1010 to a grounded point may change. An inductance value L of an antenna device may change according to the length from a branch point of a radiator of the main antenna unit 1010 to a point connected to a ground.

In response to the sub-resonance generator 1020 being activated, a capacitance value C applied to the impedance matcher may change, and thus a capacitance value C applied to the antenna device may change.

In response to the sub-resonance generator 1020 being activated, an inductance value L and a capacitance value C of the antenna device may change and thus, a sub-resonance may be generated. Due to the sub-resonance, a position of a main resonance may change.

The controller 1040 may control the switching unit 1030 according to the third frequency band to which a position of a main resonance may be shifted. The controller 1040 may select at least one impedance matching circuit among a plurality of impedance matching circuits according to the third frequency band. The controller 1040 may control whether the switch is opened or closed depending on which impedance matching circuit is selected.

The controller 1040 may select several switches among a plurality of switches included in the switching unit 1030, and may close the selected switches. In response to the selected switches being closed, an impedance of an antenna may be variously changed, and a main resonance of a mobile terminal may be shifted.

The second frequency band in which a sub-resonance is generated may correspond to a frequency band that is higher than the first frequency band, resulting in a main resonance being shifted to a lower frequency band. Thus, the third frequency band to which the main resonance shifts may correspond to a lower frequency band than the first frequency band.

The second frequency band in which a sub-resonance is generated may correspond to a frequency band lower than the first frequency band, resulting in a main resonance being shifted to a higher frequency band. Thus, the third frequency band to which the main resonance shifts may correspond to a frequency band higher than the first frequency band.

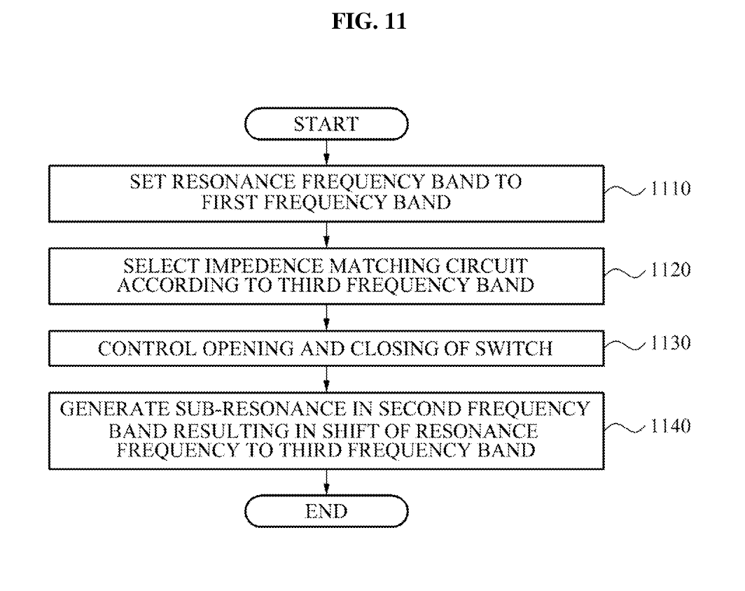

FIG. 11 is a flowchart illustrating a method for operating an antenna device of a mobile terminal according to an exemplary embodiment of the present invention.

In operation 1110, an antenna device may set a first frequency band to a resonance frequency band using a main antenna. The antenna device may generate a main resonance in the first frequency band using the main antenna. The first frequency band may correspond to a frequency band generated by a single band, dual bands, triple bands, etc. If the first frequency band corresponds to more than a single band, the first frequency band may include a plurality of discontinuous frequency bands.

In operation 1120, the antenna device may select at least one of a plurality of impedance matching circuits according to a third frequency band to which the main resonance is to be shifted.

In operation 1130, the antenna device may control the opening and the closing of a switch corresponding to each impedance matching circuit selected. In response to a switch being closed, an impedance matching circuit and a sub-resonance generator corresponding to the switch may be activated. In response to the switch being opened, an impedance matching circuit and the sub-resonance generator corresponding to the switch may be deactivated.

Depending on ON/OFF states of the switch, an inductance value of the antenna device may change according to a length from a branch point of the sub-resonance generator and the main antenna to a point at which the sub-resonance generator is grounded. A capacitance value of the antenna may change according to a capacitance of an impedance matching circuit corresponding to a closed switch and the sub-resonance generator. An impedance of the antenna device may change based on a switch that is closed, among a plurality of switches, and based on a combination of closed switches. A sub-resonance and the main resonance may be controlled according to a change of an impedance of the antenna device.

The sub-resonance generator may be connected to the main antenna physically or electrically.

In operation 1140, the sub-resonance generator may generate a sub-resonance in a second frequency band in operation 1130. In response to the sub-resonance being generated, the main resonance may shift from the first frequency band to the third frequency band. A portion of the first frequency band may overlap the third frequency band.

The second frequency band in which the sub-resonance is generated may correspond to a frequency band that is higher than the first frequency band and the main resonance may be shifted to a lower frequency band. The third frequency band to which the main resonance shifts may correspond to a frequency band that is lower than the first frequency band and the main resonance may be shifted to a higher frequency band.

The second frequency band in which the sub-resonance is generated may correspond to a frequency band that is lower than the first frequency band and, the main resonance may shift to a higher frequency band. The third frequency band to which the main resonance shifts may correspond to a frequency band that is higher than the first frequency band.

According to exemplary embodiments of the present invention, it may be possible to incorporate a miniaturized multi-band antenna in a mobile terminal.

According to exemplary embodiments of the present invention, it may be possible to change a frequency band in which a mobile terminal may transmit and receive data.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the well-known variety and available to those having skill in the computer software arts. Examples of non-transitory computer-readable media include magnetic media such as hard disks, floppy disks, and magnetic tape; optical media such as CD ROM discs and DVD; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile device, comprising:
a main antenna unit to transmit and receive signals in a first frequency band; and
a sub-resonance generator with a changeable length to modify the first frequency band;
wherein if the sub-resonance generator is operated, the first frequency band is shifted to a second frequency band in which signals are transmittable and receivable.

2. The mobile device of claim 1, further comprising:
a first impedance matcher connected to the sub-resonance generator; and
a first switch connected to the first impedance matcher,
wherein the opening or closing of the first switch changes the length of the sub-resonance generator, and at least one of an inductance value or a capacitance value of the antenna device.

3. The mobile device of claim 2, wherein the main antenna unit comprises a high band radiator and a low band radiator.

4. The mobile device of claim 2, wherein the sub-resonance generator is physically connected to the main antenna unit.

5. The mobile device of claim 4, wherein the sub-resonance generator is directly connected to the main antenna unit.

6. The mobile device of claim 2, wherein the sub-resonance generator is electrically coupled to the main antenna unit without being physically connected to the main antenna unit.

7. The mobile device of claim 2, further comprising:
a signal feeding unit to provide a signal to the main antenna unit.

8. The mobile device of claim 3, wherein the sub-resonance generator is physically connected to at least one of the low band radiator and the high band radiator of the main antenna unit.

9. The mobile device of claim 3, wherein the sub-resonance generator is electrically coupled to at least one of the low band radiator and the high band radiator of the main antenna unit without being connected to the antenna unit.

10. The mobile device of claim 2, further comprising:
a second impedance matcher connected to the sub-resonance generator; and
a second switch connected to the second impedance matcher,
wherein the closing of the second switch increases the length of the sub-resonance generator.

11. The mobile device of claim 10, wherein the first impedance matcher and the second impedance matcher are connected to the sub-resonance generator in parallel.

12. A method for transmitting and receiving a signal in a mobile device, comprising:
generating a first main resonance in a first frequency band;
generating a sub-resonance in a second frequency band to shift the first frequency band to a third frequency band; and
transmitting and receiving a signal in the third frequency band.

13. The method of claim 12, wherein the second frequency band has a lower frequency than the first frequency band so that the third frequency band is higher than the first frequency band.

14. The method of claim 12, wherein the second frequency band has a higher frequency than the first frequency band so that the third frequency band is lower than the first frequency band.

15. The method of claim 12, wherein the second frequency band and the first frequency band overlap.

16. The method of claim 12, wherein the second frequency band and the first frequency band do not overlap.

17. The method of claim 12, wherein the second frequency band includes a low frequency band and a high frequency band.
